(19) United States
(12) Patent Application Publication
(10) Pub. No.: US 2007/0100111 A1
(43) Pub. Date: May 3, 2007

(54) Alkoxysilane terminated prepolymers

(75) Inventors: Volker Stanjek, Munich (DE); Carolin Kinzler, Munich (DE); Wolfram Schindler, Tussling (DE); Richard Weidner, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: CONSORTIUM FUER ELEKTROCHEMISCHE INDUSTRIE GMBH, Munich (DE)

(21) Appl. No.: 10/595,010

(22) PCT Filed: Jun. 3, 2004
(86) PCT No.: PCT/EP04/06010

§ 371 Date: Dec. 15, 2005

(30) Foreign Application Priority Data
Jun. 26, 2003 (DE) 103 28 844.9

(51) Int. Cl. C08G 18/00

(52) U.S. Cl. 528/44

(57) ABSTRACT

Alkoxysilyl-terminated preopolymers prepared by reacting an alkoxysilane with a prepolymer prepared by reacting a di- or polyisocyanate with both a low molecular weight diol or polyol and a high molecular weight polyol, the respective polyol components present within a specific ratio range, and giving rise to an increased content of urethane groups, and an inhomogenous distribution thereof exhibit high tensile strength and elongation, even without the use of fillers.

Alkoxysilane-terminated prepolymers The invention relates to alkoxysilane-terminated prepolymers and to compositions comprising prepolymers. Prepolymer systems which possess reactive alkoxysilyl groups have been known for a long time and are widely used for producing elastic sealants and adhesives in the industrial and construction sectors. In the presence of atmospheric humidity and appropriate catalysts these alkoxysilane-terminated prepolymers are capable even at room temperature of undergoing condensation with one another, with the elimination of the alkoxy groups and the formation of an Si—O—Si bond. Consequently these prepolymers can be used, inter alia, as one-component systems, which possess the advantage of ease of handling, since there is no need to measure out and mix in a second component.

A further advantage of alkoxysilane-terminated prepolymers lies in the fact that curing is not accompanied by release either of acids or of oximes or amines. Moreover, in contrast to isocyanate-based adhesives or sealants, no CO₂ is formed either, which as a gaseous component can lead to bubbles forming. In contrast to isocyanate-based systems, alkoxysilane-terminated prepolymer mixtures are also toxicologically unobjectionable in each case. Depending on the amount of alkoxysilane groups and their structure, the curing of this type of prepolymer is accompanied by the formation principally of long-chain polymers (thermoplastics), relatively wide-meshed three-dimensional networks (elastomers) or else highly crosslinked systems (thermosets).

Alkoxysilane-terminated prepolymers may be composed of different units. These prepolymers typically possess an organic backbone; in other words they are composed, for example of polyurethanes, polyethers, polyesters, polyacrylates, polyvinyl esters, ethylene-olefin copolymers, styrene-butadiene copolymers or polyolefins, described inter alia in EP 0 372 561, EP 0 269 819, WO 00/37533, U.S. Pat. No. 6,207,766, and U.S. Pat. No. 3,971,751. In addition, however, systems whose backbone is composed entirely or at least partly of organosiloxanes are also widespread, and are described inter alia in WO 96/34030 and U.S. Pat. No. 5,254,657.

In one particularly advantageous preparation process alkoxysilane-terminated prepolymers are reacted by reaction of polyols, such as of polyester or polyether polyols, with a γ-isocyanatopropylalkoxysilane. As an alternative it is also possible here to react OH-terminated prepolymers, prepared from a polyol and a substoichiometric amount of a di- or polyisocyanate, with a γ-isocyanatopropylalkoxysilane to give alkoxysilane-terminated prepolymers. Systems of this kind are described for example in EP 0 931 800, EP 0 070 475 or U.S. Pat. No. 5,068,304.

A second particularly advantageous preparation process for alkoxysilane-terminated prepolymers starts from polyols, such as from polyether or polyester polyols, which in a first reaction step are reacted with an excess of a di- or polyisocyanate. Subsequently the resultant isocyanate-terminated prepolymers are reacted with a y-aminopropyl-functional alkoxysilane to give the desired alkoxysilane-terminated prepolymer. Systems of this kind are described for example in EP 1 256 595, EP 0 569 360 or EP 0 082 528 or DE 198 49 817.

In DE 198 49 817, moreover, it is observed that for the preparation of the isocyanate-terminated prepolymers employed therein as intermediate it is also possible if desired to use, in addition, minor amounts of dihydric and trihydric alcohols of low molecular weight.

However, these minor amounts of an alcohol do not result in any improvements at all in the properties of the resulting prepolymers or their curing products. A disadvantage of the systems described is their no more than moderate reactivity with respect to moisture, either in the form of atmospheric humidity or in the form of existing or added water. In order to achieve a sufficient cure rate at room temperature it is therefore vital to add a catalyst. The principal reason why this presents problems is that the organotin compounds commonly employed as catalysts are toxicologically objectionable. Moreover, the tin catalysts often also contain traces of highly toxic tributyltin derivatives.

A particular problem is the relatively low reactivity of the alkoxysilane-terminated prepolymers if the terminations used are not methoxysilyls but rather the even less reactive ethoxysilyls. Ethoxysilyl-terminated prepolymers specifically, however, would be particularly advantageous in many cases since their curing is accompanied by the release only of ethanol as a cleavage product.

In order to circumvent this problem, attempts have already been made to look for tin-free catalysts. Consideration might be given here, in particular, to titanium catalysts, such as titanium tetraisopropoxide or bis(acetylacetonato)diisobutyl titanate (described inter alia in EP 0 885 933). These titanium catalysts, though, possess the disadvantage that they cannot be used together with numerous nitrogen compounds, since the latter act here as catalyst poisons. The use of nitrogen compounds, as adhesion promoters for example, would nevertheless be desirable in many cases. Moreover, nitrogen compounds, aminosilanes for example, serve in many cases as reactants in the preparation of the silane-terminated prepolymers.

Accordingly, alkoxysilane-terminated prepolymer systems of the kind described, for example, in DE 101 42 050 may represent a great advantage. A feature of these prepolymers is that they contain alkoxysilyl groups separated only by a methyl spacer from an electronegative heteroatom having at least one free electron pair, i.e., from an oxygen, nitrogen or sulfur atom. As a result, these prepolymers possess extremely high reactivity with respect to (atmospheric) humidity, and accordingly can be processed to prepolymer blends which can manage even with little catalyst or even without catalysts which contain titanium, tin or other (heavy) metals, and yet cure at room temperature with sufficiently short tack-free times and at a sufficiently high rate.

In DE 101 42 050, furthermore, it is observed that alkoxysilane-terminated prepolymers can in principle be prepared using even monomeric alcohols/amines having at least two OH/NH functions in combination with di- or polyisocyanates and with organofunctional silanes. In this case, however, no description is given at all of alcohol/amine contents or else of proportions between the monomeric alcohols/amines and other prepolymer units, leading to an improvement in the properties of the prepolymer. Nor is there any description of how the use of monomeric alcohols/amines in the prepolymer synthesis might be suitable at all for improving properties of silane-terminated prepolymers or their curing products.

All alkoxysilane-terminated prepolymers of the prior art, however, have the disadvantage that they cure only to materials having a moderate tensile strength and/or breaking elongation. The sole exception here are systems with a high level of urea units in the prepolymer, as described for example in DE 21 55 258.

However, this high level of urea units means that even in the uncrosslinked state these prepolymers are solid and can be handled only in highly diluted solutions with a solids content <<50%. For the majority of applications prepolymer solutions of this kind are completely unsuitable.

Silane-crosslinking blends which cure to materials with high tensile strength and breaking elongation are sought in particular for adhesive applications, in the automobile industry among others.

One approach to improving the tensile strength of alkoxysilane-crosslinking adhesives may be represented by the use of optimized filler mixtures incorporated into the alkoxysilane-terminated polymer. One such process is described in EP 1 256 595. There, a particular variety of carbon black is mixed, along with finely divided, coated calcium carbonate, into an alkoxysilane-terminated prepolymer. Although this system did allow outstanding tensile strengths to be achieved, of 4.0-5.9 MPa, the breaking elongations that were achievable were unsatisfactory at 250%-300%. Moreover, only black adhesives can be produced using carbon black-filled materials of this kind. Other colors, although often desired, are not possible. Furthermore, it may be desirable to omit fillers entirely, if, for example, transparent materials are required for optical reasons.

The object was to provide materials based on silane-terminated prepolymers and exhibiting improved tensile strength and breaking elongation, but devoid of the aforementioned disadvantages.

The invention provides prepolymers (A) having end groups of the general formula [1]
—SiR¹ₐ(OR²)₃₋ₐ [1]
where

R¹ is an optionally halogen-substituted alkyl, cycloalkyl, alkenyl or aryl radical having 1-10 carbon atoms,

R² is an alkyl radical having 1-6 carbon atoms or an ω-oxaalkyl-alkyl radical having in all 2-10 carbon atoms, and

a is a number from 0 to 2,

the prepolymers (A) being obtainable by reacting

1) polyol (Al) having an average molecular weight Mn of 1000 to 25 000,

2) low molecular weight alcohol (A2) having at least two hydroxyl groups per molecule and a molecular weight of 62 to 300,

3) di- or polyisocyanate (A3), and

4) alkoxysilane (A4) possessing an isocyanate group or an isocyanate-reactive group,

the low molecular weight alcohol (A2) and the polyol (A1) being used in a molar ratio of 0.3:1 to 7:1.

For the preparation of the alkoxysilane-crosslinking prepolymers (A) not only di- or polyisocyanates and organofunctional silanes but also a defined mixture of long-chain polyols (A1) and low molecular weight alcohols (A2) is used. After crosslinking, the prepolymers (A) thus prepared, independently of any fillers used, have a considerably improved tensile strength and also a considerably improved breaking elongation. Materials (M) as well which comprise the silane-terminated prepolymers (A) exhibit the improved tensile strength and breaking elongation.

The prepolymers (A) are preferably isocyanate-free.

A preferred molar ratio of the low molecular weight alcohol (A2) to the polyol (A1) is from 0.5:1 to 5:1, particular preference being given to a ratio of these two components of 0.7:1 to 3:1. In the case both of the low molecular weight alcohol (A2) and of the polyol (A1) compounds having two OH groups are preferred, and in the prepolymer synthesis lead to linear and unbranched prepolymers (A).

The mode of action of the combination of a low molecular weight alcohol (A2) and a polyol (A1) during the prepolymer synthesis consists firstly in the fact that the use of the alcohol (A2) in the prepolymer synthesis leads, through its reaction with the isocyanate groups of the di- or polyisocyanates (A3) or with an isocyanate-functional silane (A4), where present, to an increased density of urethane units in the resulting polymer chain. This enhances the mechanical properties of the prepolymers (A) and materials (M) comprising prepolymers (A) after their curing.

In particular, however, the use of the low molecular weight alcohol (A2) in combination with one or more long-chain polyols (A1) leads to the formation of prepolymer chains in which the distribution of the urethane units is nonuniform. Thus, by incorporation of a polyol molecule (A1) into the prepolymer chain, a long chain section free of urethane groups is always formed, whereas the incorporation of the low molecular mass alcohol (A2) leads always to (at least) two urethane units separated only by a very short chain section consisting of a few carbon atoms. Where polyol (A1) and low molecular weight alcohol (A2) are used in the inventive relative proportion to one another, this nonuniform arrangement of the urethane units within the polymer has an unusually positive effect on the tensile strength of the cured material (M). Thus with the prepolymers (A) it is possible to produce materials (M) having significantly better tensile strength than is possible with conventional prepolymers having a relatively uniform distribution of the urethane units within the prepolymer chain. This is even the case when the prepolymers (A) and noninventive prepolymers match one another in their other features, such as average chain length and density of urethane, urea, and silyl groups, and when both polymers are composed of the same type of polyol (e.g. polypropylene glycol), and same types of isocyanate and silane.

In one preferred embodiment of the invention the alkoxysilane-terminated polymers (A) possess end groups of the general formula [2]
-A-CH₂—SiR¹ₐ(OR²)₃₋ₐ [2]
where

A is a divalent linking group selected from —O—, —S—, —(R³)N—, —O—CO—N(R³)—, —N(R³)—CO—O—, —NH—CO—NH—, —N(R⁴)—CO—NH—, —NH—CO—N(R⁴)—, and —N(R⁴)—CO—N(R⁴)—,

R³ is hydrogen, an optionally halogen-substituted cyclic, linear or branched C₁ to C₁₈ alkyl radical or alkenyl radical or a C₆ to C₁₈ aryl radical,

R⁴ is an optionally halogen-substituted cyclic, linear or branched C₁ to C₁₈ alkyl radical or alkenyl radical or a C₆ to C₁₈ aryl radical,

and R¹, R² and a are as defined for the general formula [1].

A feature of the polymers (A) having end groups of the general formula [2] is that they contain alkoxysilyl groups separated only by a methyl spacer from an electronegative heteroatom having at least one free electron pair. As a result, these polymers possess an extremely high reactivity toward (atmospheric) humidity, and can therefore be processed to polymer blends (M) which, even with little or even no tin catalyst, preferably with no tin or titanium catalyst, more preferably entirely without heavy metal catalyst, cure at room temperature with sufficiently short tack-free times and at a sufficiently high rate.

Preferred radicals R¹ are methyl, ethyl or phenyl groups. The radicals R² are preferably methyl or ethyl groups, hydrogen is preferred as radical R³, while the radicals R⁴ are preferably alkyl radicals having 1-4 carbon atoms, cyclohexyl radicals, and phenyl radicals.

Particular preference is given to alkoxysilyl-terminated polymers (A) whose crosslinkable alkoxysilyl groups are separated by a methyl spacer from a linking group such as urethane or urea groups, i.e., polymers (A) of the general formula [2] in which A is selected from the groups —O—CO—N(R³)—, —N(R³)—CO—O—, —N(R⁴)—CO—NH—, and —NH—CO—N (R⁴)—.

Particularly advantageous properties are possessed in this context by prepolymers (A) which are terminated with alkoxysilyl groups of the general formula [2] if at least 50% of these alkoxysilyl groups are composed of dialkoxysilyl groups (formula [2] with a=1). Thus, too high a level of monoalkoxysilyl groups in the prepolymers (A) may lead to a loss of tensile strength, while high levels of trialkoxysilylgroups may lead to a reduction in the breaking elongation without significantly raising the tensile strength. The corresponding prepolymers (A) at least 50% of whose alkoxysilyl groups are composed of dialkoxysilyl groups of the general formula [2] with a=1 are therefore preferred. Particular preference is given to prepolymers (A) having a fraction of dialkoxysilyl groups of the general formula [2] of at least 70%, with prepolymers (A) containing exclusively dialkoxysilyl groups of the general formula [2] being not only particularly preferred but also easy to obtain logistically, since their preparation requires only one type of silane (A4).

The main chains of the alkoxysilane-terminated polymers (A) may be branched or unbranched, preference being given to main chains which are unbranched or have only low degrees of branching. The average chain lengths can be adapted arbitrarily, in accordance with the particular desired properties both of the uncrosslinked mixture and of the cured material.

As polyols (A1) for the preparation of the prepolymers (A) it is possible in principle to use all polyols having an average molecular weight Mn of 1000 to 25 000. These may be, for example, hydroxyl-functional polyethers, polyesters, polyacrylates and polymeth-acrylates, polycarbonates, polystyrenes, polysiloxanes, polyamides, polyvinyl esters, polyvinyl hydroxides or polyolefins such as polyethylene, polybutadiene, ethylene-olefin copolymers or styrene-butadiene copolymers, for example.

Preference is given to using polyols (Al) having a molecular weight Mn of 2000 to 25 000, more preferably of 4000 to 20 000. Particularly suitable polyols (A1) are aromatic and/or aliphatic polyester polyols and polyether polyols, of the kind widely described in the literature. The polyethers and/or polyesters that are used as polyols (A1) may be either linear or branched, although preference is given to unbranched, linear polyols. Moreover, polyols (A1) may also possess substituents such as halogen atoms.

As polyols (A1) it is also possible as well to use hydroxyalkyl- or aminoalkyl-terminated polysiloxanes of the general formula [3]
Z-R⁶—[Si(R⁵)₂—O—]ₙ—Si(R⁵)₂—R⁶-Z [3]
in which

R⁵ is a hydrocarbon radical having 1 to 12 carbon atoms, preferably methyl radicals,

R⁶ is a branched or unbranched hydrocarbon chain having 1-12 carbon atoms, preferably n-propyl,

n is a number from 1 to 3000, preferably a number from 10 to 1000, and

Z is an OH or NHR³ group

and R3 is as defined for the general formula [2].

It will be appreciated that the use of any desired mixtures of the various types of polyol is also possible. Particular preference, however, is given to using linear polyether polyols, especially polypropylene glycols, as polyols (A1).

Suitable low molecular weight alcohols having at least two hydroxyl groups per molecule (A2) include in principle all such compounds having a molecular weight of 32 to 300. It is, however, preferred here to use low molecular weight diols, such as glycol, 1,3-propane-diol, 1,3-butanediol, 1,4-butanediol, all regioisomeric pentadiols and hexadiols, and also ethylene glycol or propylene glycol. One particularly preferred low molecular weight alcohol (A2) is 1,4-butanediol.

As di- or polyisocyanates (A3) for preparing the prepolymers (A) it is possible in principle to use all customary isocyanates, of the kind widely described in the literature. Common diisocyanates (A3) are, for example, diisocyanatodiphenylmethane (MDI), both in the form of crude or technical MDI and in the form of pure 4,4′ and/or 2,4′ isomers or mixtures thereof, tolylene diisocyanate (TDI) in the form of its various regioisomers, diisocyanatonaphthalene (NDI), isophorone diisocyanate (IPDI), perhydrogenated MDI (H-MDI) or else hexamethylene diisocyanate (HDI). Examples of polyisocyanates (A3) are polymeric MDI (P-MDI), triphenylmethane triisocyanate, or isocyanurate triisocyanates or biuret triisocyanates. All di- and/or polyisocyanates (A3) can be used individually or else in mixtures. It is preferred, however, to use exclusively diisocyanates. If the UV stability of the prepolymers (A) or of the cured materials produced from these prepolymers is significant because of the particular application, it is preferred to use aliphatic isocyanates as component (A3).

As alkoxysilanes (A4) for preparing the prepolymers (A) it is possible in principle to use all alkoxysilanes which possess either an isocyanate function or an isocyanate-reactive group. The alkoxysilanes serve to incorporate the alkoxysilyl terminations into the prepolymers (A). As alkoxysilanes (A4) it is preferred to use compounds selected from silanes of the general formulae [4] and [5] 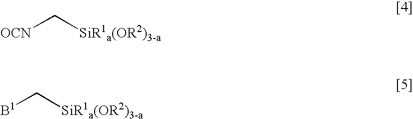
where

B¹ is an OH, SH or NH₂ group or a group HR⁴N and R¹, R², R⁴ and a are as defined for the general formulae [1] and [2].

The isocyanate-reactive group B¹ in the general formula [5] is preferably a group HR⁴N.

It is possible in this context to use individual silanes (A4) and also mixtures of different silanes (A4). The silanes in question can be prepared by a reaction of chloromethyltrialkoxysilane, chloromethyl-dialkoxymethylsilane or chlorodimethylalkoxymethyl-silane with an amine of the general formula NH₂R⁴, in other words from very simple and inexpensive reactants, in only one reaction step, without problems.

The prepolymers (A) are prepared by simply combining the components described, with the possible addition, if desired, of a catalyst and/or with the possibility, if desired of working at elevated temperature. The isocyanate groups of the di- and/or polyisocyanates (A3) and also—if present—the isocyanate groups of the silane of the general formula [4] react with the OH and/or NH functions of the added polyols (A1) and low molecular weight alcohols (A2) and also—if present—with the OH and/or NH functions of the silanes of the general formula [5]. On account of the relatively high exothermicity of these reactions it may be advantageous to add the individual components in succession in order to allow better control of the quantity of heat given off. The sequence and rate of addition of the individual components can be configured in any desired way. The various raw materials as well can be introduced initially and/or added either individually or in mixtures. Continuous prepolymer preparation, in a tube reactor for example, is also possible.

The concentrations of all isocyanate groups and all isocyanate-reactive groups involved in all reaction steps, and also the reaction conditions, are preferably selected such that all of the isocyanate groups are consumed by reaction in the course of the prepolymer synthesis. The finished prepolymer (A) is therefore isocyanate-free. In one preferred embodiment of the invention the concentration ratios and the reaction conditions are selected such that virtually all of the chain ends (>80% of the chain ends, more preferably >90% of the chain ends) of the prepolymers (A) are terminated with alkoxysilyl groups.

In one preferred preparation process the isocyanate component (A3) is reacted in a first reaction step with the polyol component (A1) and also with the alcohol component (A2), giving—in accordance with the proportions employed—a hydroxyl-terminated or isocyanate-terminated prepolymer. Components (A1) and (A2) here can be used in succession or else as a mixture. In a second reaction step these hydroxyl- or isocyanate-terminated prepolymers are then reacted with a silane of the general formula [4] or [5], the concentrations being selected such that all of the isocyanate groups are consumed by reaction. This results in the silane-terminated prepolymer (A). Special purification or other working up of the prepolymer (A) is unnecessary.

With this preparation process it is preferred to use aminosilanes of the general formula [4] with B¹═HR⁴N— as silanes (A4) and to carry out reaction with an isocyanate-terminated prepolymer. In one particularly preferred embodiment of the invention the silane here is employed in excess. The excess is preferably 20-400%, more preferably 50-200%. The excess silane can be added to the prepolymer at any desired point in time, although the silane excess is preferably added during the synthesis of the prepolymers (A).

If an excess of a silane (A4) of the general formula [5] is used in the preparation of the prepolymers (A), the prepolymers (A) can be used to produce materials (M) having a particularly high tensile strength.

The reactions between isocyanate groups and isocyanate-reactive groups which occur during the preparation of the prepolymers (A) can if desired be accelerated by means of a catalyst. It is preferred in this case to use the same catalysts listed below as curing catalysts (C). It may even be possible for the preparation of the prepolymers (A) to be catalyzed by the same catalysts which later also serve as curing catalysts (C) when curing the finished prepolymer blends. This has the advantage that the curing catalyst (C) is already present in the prepolymer (A) and need no longer be added separately during the compounding of the finished prepolymer blend (M). It will be appreciated that in lieu of one catalyst it is also possible to employ combinations of two or more catalysts.

In order to achieve rapid curing of the compositions (M) at room temperature it is possible if desired to add a curing catalyst (C). As already mentioned, suitable catalysts here include, among others, the organotin compounds typically used for this purpose, such as dibutyltin dilaurate, dioctyltin dilaurate, dibutyltin diacetylacetonate, dibutyltin diacetate or dibutyltin dioctoate, etc. In addition it is also possible to use titanates, e.g., titanium(IV) isopropoxide, iron(III) compounds, e.g., iron(III) acetylacetonate, or else amines, e.g., triethylamine, tributylamine, 1,4-diazabicyclo[2.2.2]octane, 1,8-diazabicyclo[5.4.0]undec-7-ene, 1,5-diazabicyclo-[4.3.0]non-5-ene, N,N-bis(N,N-dimethyl-2-aminoethyl)-methylamine, N,N-dimethylcyclohexylamine, N,N-dimethyl-phenylamine, N-ethylmorpholine, etc. Organic or inorganic Bronsted acids as well, such as acetic acid, trifluoroacetic acid or benzoyl chloride, hydrochloric acid, phosphoric acid and its mono- and/or diesters, such as butyl phosphate, (iso)propyl phosphate, dibutyl phosphate, etc., are suitable as catalysts (C). In addition, however, it is also possible here to use numerous further organic and inorganic heavy metal compounds and also organic and inorganic Lewis acids or Lewis bases. Moreover, the crosslinking rate may also be increased further, or matched precisely to the particular requirement, by means of combining different catalysts or combining catalysts with different cocatalysts. Distinct preference is given here to blends (M) which comprise prepolymers (A) having highly reactive alkoxysilyl groups of the general formula [2], and hence do not require heavy metal catalysts (C), in order to achieve cure times which are sufficiently short even at room temperature.

The use of prepolymers (A) having silane termini of the general formula [2] has the particular advantage, moreover, that it allows the preparation even of prepolymers (A) which contain exclusively ethoxysilyl groups, i.e., silyl groups of the general formula [2] with R²=ethyl. The moisture reactivity of these compositions (M) is such that even without tin catalysts they cure at a sufficiently high rate, despite the fact that ethoxysilyl groups generally are less reactive than the corresponding methoxysilyl groups. Thus even with ethoxysilane-terminated polymers (A) tin-free systems are possible. Polymer blends (M) of this kind, containing exclusively ethoxysilane-terminated polymers (A), possess the advantage that on curing they release only ethanol as a cleavage product. They represent a preferred embodiment of this invention.

The prepolymers (A) are preferably employed in blends (M) which additionally comprise low molecular weight alkoxysilanes (D). These alkoxysilanes (D) may take on a number of functions. For example, they may serve as water scavengers—that is, they are intended to scavenge any traces of moisture that may be present, and so to increase the storage stability of the corresponding silane-crosslinking compositions (M). It will be appreciated that their reactivity toward traces of moisture must be at least comparable with that of the prepolymer (A). Suitability as water scavengers is therefore possessed in particular by highly reactive alkoxysilanes (D) of the general formula [6] 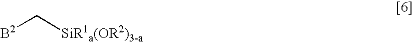
where

B² is a group R⁴O—CO—NH, R⁴R³N—CO—NH, OH, OR, SH, SR⁴, NH₂, NHR⁴, or N(R⁴)₂ and

R¹, R², R³, R⁴ and a are as defined for the general formulae [1] and [2]. A particularly preferred water scavenger is the carbamatosilane in which B² is a group R⁴O—CO—NH.

The low molecular weight alkoxysilanes (D) may, furthermore, also serve as crosslinkers and/or reactive diluents. Suitability for this purpose is possessed in principle by all silanes which possess reactive alkoxysilyl groups via which they can be incorporated, during the curing of the polymer blend, into the three-dimensional network that forms. The alkoxysilanes (D) may in this case contribute to an increase in the network density and hence to an improvement in the mechanical properties, such as the tensile strength, of the cured material (M). Moreover, they may also lower the viscosity of the prepolymer blends in question. Examples of suitable alkoxysilanes (D) in this function include alkoxymethyltrialkoxysilanes and alkoxymethyl-dialkoxyalkylsilanes. Preferred alkoxy groups are methoxy and ethoxy groups. Furthermore, the inexpensive alkyltrimethoxysilanes, such as methyltrimethoxysilane and also vinyl- or phenyltrimethoxysilane, and their partial hydrolysates, may also be suitable.

The low molecular weight alkoxysilanes (D) may additionally serve as adhesion promoters. Here it is possible in particular to use alkoxysilanes which possess amino functions or epoxy functions. Examples that may be mentioned include γ-aminopropyl-trialkoxysilanes, γ-[N-aminoethylamino]propyltrialkoxy-silanes, γ-glycidyloxypropyltrialkoxysilanes, and all silanes of the general formula [6] in which B² is a nitrogen-containing group.

Finally, the low molecular weight alkoxysilanes (D) may even serve as curing catalysts or cocatalysts. Suitability for this purpose is possessed in particular by all basic amino silanes, such as all aminopropyl-silanes, N-aminoethylaminopropylsilanes, and also all silanes of the general formula [6] with the proviso that B² is an NH₂ group or a group NHR⁴ or N(R⁴)₂.

The alkoxysilanes (D) can be added to the prepolymers (A) at any desired point in time. Where they do not possess NCO-reactive groups, they can even be added during the synthesis of the prepolymers (A). In this context it is possible, based on 100 parts by weight of prepolymer (A), to add up to 100 parts by weight, preferably 1 to 40 parts by weight, of a low molecular weight alkoxysilane (D).

Furthermore, fillers (E) are typically added to blends of the alkoxysilane-terminated prepolymers (A). These fillers (E) lead to a considerable improvement in the properties of the resultant blends (M). The tensile strength in particular, and also the breaking elongation, can be raised considerably through the use of appropriate fillers.

Appropriate fillers (E) include all materials of the kind widely described in the prior art. Examples of fillers are nonreinforcing fillers, i.e. fillers having a BET surface area of up to 50 m²/g, such as quartz, diatomaceous earth, calcium silicate, zirconium silicate, zeolites, calcium carbonate, metal oxide powders, such as aluminum, titanium, iron or zinc oxides and/or their mixed oxides, barium sulfate, calcium carbonate, gypsum, silicon nitride, silicon carbide, boron nitride, powdered glass and powdered polymers; reinforcing fillers, i.e. fillers having a BET surface area of at least 50 m²/g, such as pyrogenic (fumed) silica, precipitated silica, carbon black, such as furnace black and acetylene black, and silicon/aluminum mixed oxides of high BET surface area; and fibrous fillers, such as asbestos and also polymeric fibers. Said fillers may have been hydrophobicized, by treatment for example with organosilanes or organosiloxanes or by etherification of hydroxyl groups to alkoxy groups. It is possible to use one kind of filler (E); it is also possible to use a mixture of at least two fillers (E).

The fillers (E) are used preferably in a concentration of 0-90% by weight, based on the finished blend, with concentrations of 30-70% by weight being particularly preferred. In one preferred application use is made of filler combinations (E) which in addition to calcium carbonate also include pyrogenic silica and/or carbon black.

Compositions (M) which contain no fillers (E) are also preferred. Thus the prepolymers (A) after curing already possess a relatively high breaking elongation, and so allow even unfilled compositions (M). Advantages of unfilled systems are significantly lower viscosity and also transparency.

The blends (M) comprising the prepolymers (A) may additionally also comprise small amounts of an organic solvent (F). The purpose of this solvent is to lower the viscosity of the uncrosslinked compositions (M). Suitable solvents (F) include in principle all solvents and solvent mixtures. Solvents (F) used preferably are compounds which possess a dipole moment. Particularly preferred solvents possess a heteroatom having free electron pairs which are able to enter into hydrogen bonds. Preferred examples of such solvents are ethers such as tert-butyl methyl ether, esters, such as ethyl acetate or butyl acetate, and alcohols, such as methanol, ethanol, n-butanol or—with particular preference—tert-butanol. The solvents (F) are used preferably in a concentration of 0-20% by volume, based on the finished prepolymer mixture including all fillers (E), particular preference being given to solvent concentrations of 0-5% by volume.

Further components which may be present in the polymer blends (M) include conventional auxiliaries, such as reactive diluents and/or water scavengers other than components (D), and also adhesion promoters, plasticizers, thixotropic agents, fungicides, flame retardants, pigments, etc. Additionally, light stabilizers, antioxidants, free-radical scavengers and further stabilizers may be added to the compositions (M). To produce the particular desired profiles of properties, both of the uncrosslinked polymer blends (M) and also of the cured materials (M), additions of this kind are preferred.

Countless different applications exist for the polymer blends (M) in the areas of adhesives, sealants, and joint-sealing compounds, in surface coatings, and also in the production of moldings. On account of their improved tensile strength the compositions (M) are particularly suitable for adhesive applications. The use of the prepolymers (A) and polymer blends (M) in adhesives is therefore preferred. They are suitable for countless different substrates, such as mineral substrates, metals, plastics, glass, ceramics, etc.

The polymer blends (M) can be employed as they are or else in the form of solutions or dispersions.

All above symbols in the above formulae have their definitions in each case independently of one another. In all formulae the silicon atom is tetravalent.

Unless indicated otherwise, all amounts and percentages are by weight, all pressures are 0.10 MPa (abs.) and all temperatures are 20° C.

The measure indicated in each case for the reactivities of the polymer blends (M)—or for the reactivities of the noninventive polymer blends in the comparative examples—are the skinning times. By skinning times are meant the time period which elapses following application of the prepolymer in air until the polymer surface has cured to the extent that contacting said surface with a pencil no longer causes the polymer material to adhere to the pencil.

### EXAMPLE 1

Preparation of N-cyclohexylaminomethyldimethoxysilane:

1486.5 g (15 mol) of cyclohexylamine and 600 g of cyclohexane as solvent are introduced in their entirety into a 4-liter 4-neck flask and this initial charge is subsequently rendered inert using nitrogen. It is heated to a temperature of 85° C., 773.4 g (5 mol) of chloromethylmethyldimethoxysilane are added dropwise over 2 h (temperature <95° C.), and the mixture is stirred at 95° C. for 2 hours more. Following the addition of approximately 300 g of the silane there is increasing precipitation of cyclohexylamine hydro-chloride in salt form, but the suspension remains readily stirrable until the end of metering. The suspension is left to stand overnight and then approximately 300 ml of cyclohexane added. Under a partial vacuum the excess amine and the cyclohexane solvent are removed by distillation at 60-70° C. The residue is cooled and treated with a further 300 ml of cyclohexane in order to precipitate the hydrochloride completely. The suspension is filtered and the solvent is again removed under partial vacuum at 60-70° C. The residue is purified by distillation (106-108° C. at 15 mbar). A yield of 761 g, i.e. 70% of theory, is achieved, with a product purity of approximately 99.5%.

### EXAMPLE 2

Preparation of methoxymethyltrimethoxysilane (MeO-TMO):

315 ml of methanol are admixed with gentle stirring with 68 g (1.26 mol) of sodium methoxide. After the sodium methoxide has fully dissolved at 65° C., 205 g (1.2 mol) of chloromethyltrimethoxysilane are added dropwise over the course of 2 h at a temperature of 45-50° C. In the course of the slightly exothermic neutralization NaCl is precipitated. This is followed by stirring with slow cooling to 25° C. for 1 hour. NaCl is filtered off on a frit of porosity 3 and rinsed with a little methanol.

Under partial vacuum the methanol solvent is removed at 60° C. The residue is purified by distillation (78-93° C. at 90 mbar). A yield of 140 g, i.e. 70% of theory is achieved.

### EXAMPLE 3

Preparation of methyl trimethoxysilylmethylcarbamate (C-TMO):

61.3 g (7.56 mol) of extra finely ground potassium isocyanate are weighed out into a 1-liter 4-neck flask. Subsequently 404 g (0.51 l, 12.6 mol) of methanol, 184.0 g (0.196 l) of dimethylformamide and 100.7 g (0.59 mol) of chloromethyltrimethoxysilane are introduced. The reaction mixture is heated to boiling, with stirring, and is held under reflux for a total of 10 h, the boiling temperature rising from 100° C. to 128° C. and then remaining stable. After the mixture has been cooled to room temperature the potassium chloride formed is separated off on a suction filter and the filter cake is washed with 1.1 l of methanol. The methanol and dimethylformamide solvents are removed on a rotary evaporator. The remaining amounts of potassium chloride are separated off. The crude solution is purified by distillation (overhead temperature 79-85° C. at 3 mbar). In total it was possible to obtain 60.4 g (53% of theory [114 g]) of C-TMO.

### EXAMPLE 4

Preparation of a prepolymer (A):

A 250-ml reaction vessel with stirring, cooling and heating means is charged with 152 g (16 mmol) of a polypropylene glycol having an average molecular weight of 9500 g/mol (Acclaim 12200 from Bayer) and this initial charge is dewatered under reduced pressure at 80° C. for 30 minutes. The heating is then removed and, under nitrogen, 2.16 g (24 mmol) of 1,4-butanediol, 12.43 g (56 mmol) of isophoronediisocyanate and 80 mg of dibutyltin dilaurate (corresponding to a tin content of 100 ppm) are added. This mixture is stirred at 80° C. for 60 minutes. The NCO-terminated polyurethane prepolymer obtained is then cooled to 75° C. and admixed with 11.13 g (51.2 mmol) of N-cyclohexylaminomethyl-dimethoxymethylsilane, and the mixture is stirred at 80° C. for 60 minutes. In the resulting prepolymer mixture it is no longer possible to detect isocyanate groups by IR spectroscopy. A slightly turbid prepolymer is obtained which at 20° C. with a viscosity of 370 Pas can be poured and further-processed without problems.

Preparation of blends with prepolymer (A):

General instruction (The specific amounts for the individual components can be taken from Table 1. In the absence of certain components, the respective incorporation steps are omitted.):

The prepolymer described above is admixed with carbamatomethyltrimethoxysilane (C-TMO—prepared according to Example 3) and the components are mixed in a Speedmixer (DAC 150 FV from Hausschild) at 27 000 rpm for 15 seconds. Then chalk (BLR 3 from Omya), HDK V 15 (Wacker Chemie GmbH, Germany) and methoxymethyl-trimethoxysilane (MeO-TMO—prepared according to Example 2) are added and mixing is carried out for twice 20 seconds at a speed of 30 000 rpm. Finally aminopropyltrimethoxysilane (A-TMO—Silquest A1110® from Crompton) is added, followed again by mixing for 20 seconds at a speed of 30 000 rpm.

TABLE 1

| Batch number | Ex. 4-1 | Ex. 4-2 | Ex. 4-3 |
|---|---|---|---|
| Polymer | 96% | 65% | 60% |
| Chalk BLR 3 | — | 30% | 30% |
| HDK V-15 | — | — | 5% |
| Silane1 | — | 1% C-TMO | 1% C-TMO |
| Silane2 | 2% MeO-TMO | 2% MeO-TMO | 2% MeO-TMO |
| Silane3 | 2% A-TMO | 2% A-TMO | 2% A-TMO |

### COMPARATIVE EXAMPLE 1

This comparative example relates to Example 4. In this case, however, instead of a mixture of 1,4-butanediol and a polypropylene glycol with a mass of 9500, a polypropylene glycol with a mass of 4000 is used. The concentration ratios are selected such that the prepolymers from Example 4 and from comparative Example 1 have substantially the same average molecular masses, density of urethane and urea groups, and the same silane group content.

Preparation of a noninventive prepolymer:

A 250-ml reaction vessel with stirring, cooling and heating means is charged with 160 g (40 mmol) of a polypropylene glycol having an average molecular weight of 4000 g/mol and this initial charge is dewatered under reduced pressure at 80° C. for 30 minutes. The heating is then removed and, under nitrogen, 12.43 g (56 mmol) of isophoronediisocyanate and 80 mg of dibutyltin dilaurate are added. This mixture is stirred at 80° C. for 60 minutes. The NCO-terminated polyurethane prepolymer obtained is then cooled to 75° C. and admixed with 11.13 g (51.2 mmol) of N-cyclohexylaminomethyl-dimethoxymethylsilane, and the mixture is stirred at 80° C. for 60 minutes. In the resulting prepolymer mixture it is no longer possible to detect isocyanate groups by IR spectroscopy. A slightly turbid prepolymer is obtained which at 20° C. with a viscosity of 155 Pas can be poured and further-processed without problems.

Preparation of noninventive prepolymer blends:

General instruction (The specific amounts for the individual components can be taken from Table 2. In the absence of certain components, the respective incorporation steps are omitted.):

The prepolymer described above is admixed with carbamatomethyltrimethoxysilane (C-TMO—prepared according to Example 3) and the components are mixed in a Speedmixer (DAC 150 FV from Hausschild) at 27 000 rpm for 15 seconds. Then chalk (BLR 3 from Omya), HDK V 15 (Wacker Chemie GmbH, Germany) and methoxymethyl-trimethoxysilane (MeO-TMO—prepared according to Example 2) are added and mixing is carried out for twice 20 seconds at a speed of 30 000 rpm. Finally aminopropyltrimethoxysilane (A-TMO—Silquest A1110® from Crompton) is added, followed again by mixing for 20 seconds at a speed of 30 000 rpm.

TABLE 2

| Batch number | C. Ex. 1-1 | C. Ex. 1-2 | C. Ex. 1-3 |
|---|---|---|---|
| Polymer | 96% | 65% | 60% |
| Chalk BLR 3 | — | 30% | 30% |
| HDK V-15 | — | — | 5% |
| Silane1 | — | 1% C-TMO | 1% C-TMO |
| Silane2 | 2% MeO-TMO | 2% MeO-TMO | 2% MeO-TMO |
| Silane3 | 2% A-TMO | 2% A-TMO | 2% A-TMO |

### COMPARATIVE EXAMPLE 2

This comparative example relates to Example 4. In this case, however, no 1,4-butanediol is used, and the amount of isophorone diisocyanate for use is reduced accordingly.

Preparation of a noninventive prepolymer:

A 250-ml reaction vessel with stirring, cooling and heating means is charged with 152 g (16 mmol) of a polypropylene glycol having an average molecular weight of 9500 g/mol (Acclaim® 12200 from Bayer) and this initial charge is dewatered under reduced pressure at 80° C. for 30 minutes. The heating is then removed and, under nitrogen, 7.1 g (32 mmol) of isophoronediisocyanate and 80 mg of dibutyltin dilaurate are added. This mixture is then stirred at 80° C. for 60 minutes. The NCO-terminated polyurethane prepolymer obtained is then cooled to 75° C. and admixed with 11.13 g (51.2 mmol) of N-cyclohexylaminomethyl-dimethoxymethylsilane, and the mixture is stirred at 80° C. for 60 minutes. In the resulting prepolymer mixture it is no longer possible to detect isocyanate groups by IR spectroscopy. A slightly turbid prepolymer is obtained which at 20° C. with a viscosity of 77 Pas can be poured and further-processed without problems.

Preparation of noninventive prepolymer blends:

General instruction (The specific amounts for the individual components can be taken from Table 3. In the absence of certain components, the respective incorporation steps are omitted.):

The prepolymer described above is admixed with carbamatomethyltrimethoxysilane (C-TMO—prepared according to Example 3) and the components are mixed in a Speedmixer (DAC 150 FV from Hausschild) at 27 000 rpm for 15 seconds. Then chalk (BLR 3 from Omya), HDK V 15 (Wacker Chemie GmbH, Germany) and methoxymethyl-trimethoxysilane (MeO-TMO—prepared according to Example 2) are added and mixing is carried out for twice 20 seconds at a speed of 30 000 rpm. Finally aminopropyltrimethoxysilane (A-TMO—Silquest A1110® from Crompton) is added, followed again by mixing for 20 seconds at a speed of 30 000 rpm.

TABLE 3

| Batch number | C. Ex. 2-1 | C. Ex. 2-2 | C. Ex. 2-3 |
|---|---|---|---|
| Polymer [%] | 96% | 65% | 60% |
| Chalk BLR 3 [%] | — | 30% | 30% |
| HDK V-15 [%] | — | — | 5% |
| Silane1 [%] | — | 1% C-TMO | 1% C-TMO |
| Silane2 [%] | 2% MeO-TMO | 2% MeO-TMO | 2% MeO-TMO |
| Silane3 [%] | 2% A-TMO | 2% A-TMO | 2% A-TMO |

### EXAMPLE 5

Properties of the cured prepolymer blends

The finished prepolymer blend is coated out using a doctor blade into a Teflon mold 2 mm high, the rate of curing through volume being approximately 2 mm in a day. After two-week storage, S1 test specimens are punched out, and their tensile properties measured in accordance with EN ISO 527-2 on the Z010 from Zwick. The properties measured on the respective prepolymer blends are listed in Table 4. The blends of
Example 4.1, comparative Example 1.1, and comparative Example 2.1;
Example 4.2, comparative Example 1.2, and comparative Example 2.2;
Example 4.3, comparative Example 1.3, and comparative Example 2.3;

are in each case identical and differ only in the prepolymer used. In other words, the properties of these compositions can be compared directly with one another in each case.

TABLE 4

| Batch number | Ex. 4-1 | Ex. 4-2 | Ex. 4-3 |
|---|---|---|---|
| Skinning time | 1.5 h | 1.5 h | 1.5 h |
| Tensile strength [MPa] | 1.78 | 3.05 | 4.12 |
| Breaking elongation [%] | 485.46 | 724.46 | 680.8 |
| Modulus [MPa] | 0.44 | 0.8 | 1.23 |
| Shore hardness | 30 | 41 | 49 |
| Batch number | C. Ex. 1-1 | C. Ex. 1-2 | C. Ex. 1-3 |
| Skinning time | 2 h | 2 h | 30 min |
| Tensile strength [MPa] | 0.51 | 1.45 | 2.76 |
| Breaking elongation [%] | 323.28 | 488.85 | 627.32 |
| Modulus [MPa] | 0.22 | 0.44 | 0.95 |
| Shore hardness | 18 | 30 | 43 |
| Batch number | C. Ex. 2-1 | C. Ex. 2-2 | C. Ex. 2-3 |
| Skinning time | 2 h | 2 h | 55 min |
| Tensile strength [MPa] | 1.02 | 1.82 | 2.49 |
| Breaking elongation [%] | 561.76 | 507.99 | 511.28 |
| Modulus [MPa] | 0.24 | 0.53 | 0.98 |
| Shore hardness | 22 | 37 | 41 |

### EXAMPLE 6:

This example is intended to show that the prepolymers (A) are also suitable for producing unfilled prepolymer blends which are suitable for materials having an extremely high tensile strength for systems of this kind.

Preparation of a prepolymer (A):

A 250-ml reaction vessel with stirring, cooling and heating means is charged with 152 g (16 mmol) of a polypropylene glycol having an average molecular weight of 9500 g/mol (Acclaim® 12200 from Bayer) and this initial charge is dewatered under reduced pressure at 80° C. for 30 minutes. The heating is then removed and, under nitrogen, 2.88 g (32 mmol) of 1,4-butanediol, 14.21 g (64 mmol) of isophoronediisocyanate and 80 mg of dibutyltin dilaurate are added. This mixture is stirred at 80° C. for 60 minutes. The NCO-terminated polyurethane prepolymer obtained is then cooled to 75° C. and admixed with 13.91 g (64 mmol) of N-cyclohexylaminomethyldimethoxymethylsilane, and the mixture is stirred at 80° C. for 60 minutes. In the resulting prepolymer mixture it is no longer possible to detect isocyanate groups by IR spectroscopy. A slightly turbid prepolymer is obtained which at 20° C. with a viscosity of 620 Pas can be poured and further-processed without problems.

Preparation of a blend with prepolymer (A):

This prepolymer is processed as in Example 4 to a prepolymer blend. The formula used is that shown in Table 5.

TABLE 5

| Batch number | Ex. 7-1 |
|---|---|
| Polymer | 96% |
| Chalk BLR 3 | — |
| HDK | — |
| Silane1 | — |
| Silane2 | 2% MeO-TMO |
| Silane3 | 2% A-TMO |

This formula possesses a skinning time of 2 hours, a breaking elongation of 812%, a tensile strength of 2.4 MPa, and a 100% modulus of 0.3 MPa.

### COMPARATIVE EXAMPLE 3

This comparative example relates to Example 6. Here, however, no 1,4-butanediol is used, and the amount of Isophorone diisocyanate for use is reduced accordingly.

Preparation of a noninventive prepolymer:

The polymer is prepared in exactly the same way as described in Example 6 except that no butanediol was added and that 7.1 g (32 mmol) instead of 14.21 g (64 mmol) of isophorone diisocyanate are used.

Preparation of a noninventive prepolymer blend:

This prepolymer is processed as in Example 4 to a prepolymer blend. The formula used is that shown in Table 6.

TABLE 6

| Batch number | C. Ex. 5-1 |
|---|---|
| Polymer | 96% |
| Chalk BLR 3 | — |
| HDK | — |
| Silane1 | — |
| Silane2 | 2% MeO-TMO |
| Silane3 | 2% A-TMO |

### EXAMPLE 7

As described in Ex. 5, sample specimens are produced and subjected to measurement. In this case, however, the prepolymers prepared in Example 6 and in comparative Example 3 are used. The properties measured on the respective prepolymer blends are listed in Table 7.

TABLE 7

| Batch number | Ex. 6-1 | C. Ex. 3-1 |
|---|---|---|
| Skinning time | 2 h | 2 h |
| Tensile strength [Mpa] | 2.4 | 1.13 |
| Breaking elongation [%] | 812.05 | 552.31 |
| Modulus [MPa] | 0.3 | 0.23 |
| Shore hardness | 25 | 22 |

### EXAMPLE 8

This example serves further to demonstrate the performance capacity of the prepolymers (A).

Preparation of a prepolymer (A):

A 250-ml reaction vessel with stirring, cooling and heating means is charged with 152 g (16 mmol) of a polypropylene glycol having an average molecular weight of 9500 g/mol (Acclaim® 12200 from Bayer) and this initial charge is dewatered under reduced pressure at 80° C. for 30 minutes. The heating is then removed and, at 60° C. and under nitrogen, 2.16 g (24 mmol) of 1,4-butanediol, 12.43 g (56 mmol) of isophoronediisocyanate and 80 mg of dibutyltin dilaurate are added. This mixture is stirred at 80° C. for 60 minutes. The NCO-terminated polyurethane prepolymer obtained is then cooled to 60° C. and admixed with 13.91 g (64 mmol) of N-cyclohexylaminomethyldimethoxymethylsilane, and the mixture is stirred at 80° C. for 60 minutes. In the resulting prepolymer mixture it is no longer possible to detect isocyanate groups by IR spectroscopy. A slightly turbid prepolymer is obtained which at 20° C. with a viscosity of 505 Pas can be poured and further-processed without problems.

Preparation of a blend with prepolymer (A):

This prepolymer is processed as in Example 4 to a prepolymer blend. The formula used is that shown in

TABLE 8

| Batch number | Ex. 10-1 |
|---|---|
| Polymer | 57.5% |
| Chalk BLR 3 | 30% |
| HDK V15 | 7.5% |
| Silane1 | 1% C-TMO |
| Silane2 | 2% MeO-TMO |
| Silane3 | 2% A-TMO |

As described in Ex. 5, sample specimens are produced from this blend and subjected to measurement. They possessed a skinning time of 15 minutes, a tensile strength of 5.4 MPa, a breaking elongation of 667%, and a 100% modulus of 1.8 MPa.

### EXAMPLE 9

This example serves further to demonstrate the performance capacity of the prepolymers (A).

Preparation of a prepolymer (A):

The prepolymer is prepared as described in Example 4 except that instead of 11.13 g (51.2 mmol) of N-cyclo-hexylaminomethyldimethoxymethylsilane 7.42 g (34.1 mmol) and, additionally, 4.64 g (17.1 mmol) of N-cyclo-hexylaminomethyltrimethoxysilane are used.

Preparation of a blend with prepolymer (A):

This prepolymer is processed as in Example 4 to a prepolymer blend. The formula used is that depicted in Table 9.

TABLE 9

| Batch number | Ex. 10-1 |
|---|---|
| Polymer | 60% |
| Chalk BLR 3 | 30% |
| HDK V15 | 5% |
| Silane1 | 1% C-TMO |
| Silane2 | 2% MeO-TMO |
| Silane3 | 2% A-TMO |

As described in Ex. 5, sample specimens are produced from this blend and subjected to measurement. They possessed a skinning time of 5 minutes, a breaking elongation of 502%, a tensile strength of 4.2 MPa, and a 100% modulus of 1.71 MPa.

### EXAMPLE 10

This example serves further to demonstrate the performance capacity of the prepolymers.

Preparation of a prepolymer (A):

The prepolymer is prepared as described in Example 8. Sample specimens are produced accordingly, the prepolymer being admixed with Triveron® prior to blending.

Preparation of a blend with prepolymer (A):

This prepolymer is admixed with 5% by weight of Triveron® and processed as in Example 4 to a prepolymer blend. The formula used is that depicted in Table 10.

TABLE 10

| Batch number | Ex. 11-1 |
|---|---|
| Polymer | 55.0% |
| Chalk BLR 3 | 30% |
| HDK V15 | 10.0% |
| Silane1 | 1% C-TMO |
| Silane2 | 2% MeO-TMO |
| Silane3 | 2% A-TMO |

As described in Ex. 5, sample specimens are produced from this blend and subjected to measurement. They possessed a skinning time of 5 minutes, a breaking elongation of 633%, a tensile strength of 5.74 MPa, and a 100% modulus of 2.09 MPa.

1.-11. (canceled)

12. A room temperature-curing composition (M) which is not solid in the uncrosslinked state, comprising prepolymer(s) (A) having end groups of the formula [1]
−SiR¹ₐ(OR²)₃₋ₐ [1]
where
R¹ is an optionally halogen-substituted alkyl, cycloalkyl, alkenyl or aryl radical having up to 10 carbon atoms,
R² is an alkyl radical having 1-6 carbon atoms or an ω-oxaalkyl-alkyl radical having in all 2-10 carbon atoms, and
a is a number from 0 to 2,
the prepolymers (A) prepared by reacting the components
1) at least one polyol (Al) having an average molecular weight Mn of 1000 to 25,000,
2) at least one low molecular weight diol (A2) having at least two hydroxyl groups per molecule and a molecular weight of 62 to 300,
3) at least one di- or polyisocyanate (A3), and
4) at least one alkoxysilane (A4) possessing an isocyanate group or an isocyanate-reactive group,
the low molecular weight alcohol (A2) component and the polyol (A1) component being used in a molar ratio of 0.3:1 to 7:1, and
the stoichiometry and reaction conditions being selected such that more than 80% of the chain ends of the prepolymers (A) are terminated with alkoxysilyl groups.

13. The prepolymer (A) of claim 12, which is isocyanate-free.

14. The prepolymer (A) of claim 12, in which the alkoxysilane-terminated polymer (A) possesses end groups of the general formula [2]
-A-CH₂—SiR¹ₐ(OR²)₃₋ₐ [2]
where
A is a divalent linking group selected from the group consisting of —O—, —S—, —(R³)N—, —O—CO—N(R³)—, —N(R³)—CO—O—, —NH—CO—NH—, —N(R⁴)—CO—NH—, —NH—CO—N(R⁴)—, and —N(R⁴)—CO—N(R⁴)—,
R³ is hydrogen, an optionally halogen-substituted cyclic, linear or branched C₁ to C₁₈ alkyl radical or alkenyl radical or a C₆ to C₁₈ aryl radical,
R⁴ is an optionally halogen-substituted cyclic, linear or branched C₁ to C₁₈ alkyl radical or alkenyl radical or a C₆ to C₁₈ aryl radical.

15. The prepolymer (A) of claim 12 in which the polyols (A1) are hydroxyl-functional polymers selected from the group consisting of polyesters, polyacrylates, polymethacrylates, polycarbonates, polystyrenes, polysiloxanes, polyamides, polyvinyl esters, polyvinyl hydroxides and polyolefins.

16. The prepolymer (A) of claim 12, in which the low molecular weight alcohols (A2) are selected from the group consisting of 1,3-propanediol, 1,3-butanediol, 1,4-butanediol, pentanediols and hexanediols, ethylene glycol and propylene glycol.

17. The prepolymer (A) of claim 12, in which the di- or polyisocyanates (A3) are selected from the group consisting of diisocyanatodiphenylmethane, tolylene diisocyanate, diisocyanatonaphthalene, isophorone diisocyanate, perhydrogenated MDI, hexamethylene diisocyanate, polymeric MDI, triphenylmethane triisocyanate, isocyanurate triisocyanates and biuret triisocyanates.

18. The prepolymer of claim 12, in which the alkoxysilanes (A4) are selected from silanes of the formulae [4] and [5] 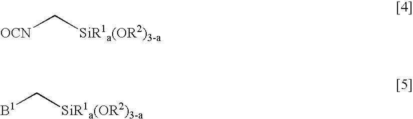
where
B¹ is an OH, SH or NH₂ group or a group HR⁴N wherein
R⁴ is an optionally halogen-substituted cyclic, linear or branched C₁ to C₁₈ alkyl radical or alkenyl radical or a C₆ to C₁₈ aryl radical.

19. A moisture curable composition (M) comprising a prepolymer of claim 12.

20. The composition (M) of claim 19, further comprising at least one filler (E) selected from the group consisting of calcium carbonate, silica, and carbon black.

21. The composition (M) of claim 19, which is devoid of fillers (E).

22. The composition (M) of claim 12, containing 0-20% by volume of an organic solvent (F).

23. The composition of claim 12, further comprising at least one alkoxysilane of the formula 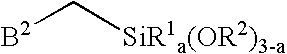
wherein B² is selected from the group consisting of R⁴O—CO—NH, R⁴R³N—CO—NH, OH, OR⁴, SH, SR⁴, NH₂, NHR⁴, or N(R⁴)₂.

24. The composition of claim 12, wherein the molar ratio of low molecular weight polyol (A2) to polyol (A1) is from 0.7:1 to 3:1.

25. The composition of claim 12 which is substantially free of water.

26. The composition of claim 19, further comprising at least one alkoxysilane of the formula 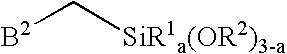
wherein B² is selected from the group consisting of R⁴O—CO—NH, R⁴R³N—CO—NH, OH, OR⁴, SH, SR⁴, NH₂, NHR⁴, or N(R⁴)₂.

27. The composition of claim 19, wherein the molar ratio of low molecular weight polyol (A2) to polyol (A1) is from 0.7:1 to 3:1.

28. The composition of claim 19 which is substantially free of water.
